(19) United States
(12) Patent Application Publication
(10) Pub. No.: US 2004/0119999 A1
(43) Pub. Date: Jun. 24, 2004

(54) Image forming apparatus, print data processing device, and print data processing method

(75) Inventor: Kenji Kogure, Iwatsuki-shi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/389,923

(22) Filed: Mar. 18, 2003

(30) Foreign Application Priority Data
Dec. 20, 2002 (JP) 2002-369194

(51) Int. Cl. G06F 15/00

(52) U.S. Cl. 358/1.13; 358/1.6

(57) ABSTRACT

A PDL decision unit analyzes the format of input PDL data to specify a PDL interpreter which must interpret the PDL data. An additional information acquisition unit acquires additional information from the PDL data to supply the additional information to a predetermined PDL interpreter. The predetermined PDL interpreter generates an additional information image on the basis of the additional information. The PDL interpreter specified by the PDL decision unit generates a main image on the basis of the PDL data. An image combining unit combines the main image and the additional information image to output a combined image through an image data output unit.

### BACKGROUND OF THE INVENTION

1. Field of the Invention

The present invention relates to an image forming apparatus, a print data processing device, and a print data processing method and, more particularly, to an image forming apparatus for combining image data and image data of additional information, a print data processing device, and a print data processing method.

2. Description of the Related Art

Conventional various image forming apparatuses for outputting images such that identification information representing a preparer of an image or the like can be identified from the image (for example, see Japanese Patent Application Laid-Open (JP-A) No. 10-109466) are provided. Such an image forming apparatus generally has an additional information pattern generation unit being independent of an emulator for generating image data. The additional pattern generation unit converts the additional information of the image data into a visible pattern to combine the pattern to the image data generated by the emulator.

On the other hand, the image forming apparatus comprises a plurality of emulators (emulation programs) to cope with different printer languages (for example, see JP-A Nos. 5-324930 and 9-30089).

However, the image forming apparatus described in the JP-A No. 10-109466 has the following problems. For example, when a pattern generated by the pattern generation unit has poor legibility, “identification” (for example, specification of a preparer) which is an essential object is difficult. On the other hand, in order to improve legibility, a pattern of character image type must be generated, and the functions of the pattern generation unit disadvantageously become complex.

For this reason, attribute information of print data is given to an emulator. The emulator itself may combine additional information having high legibility to original image data.

However, according to the above method, when a plurality of emulators exist (in JP-A Nos. 5-324930 and 9-30089), the image data generation units of these emulators must have the same functions, respectively. This is not easily realized when a third-party emulator (e.g., PostScript (R) available from Adobe Systems Incorporated or the like) which is limited in customization is used. Even if all the emulators can have these functions, respective, fonts which can be used in the emulators are generally different from each other, user interfaces (UI) are poor in uniformity.

### SUMMARY OF THE INVENTION

The present invention has been made in consideration of the above problems, and has as its object to provide an image forming apparatus which can form an integrated addition information image even though the image is output in print languages of any type, a print data processing apparatus, and a print data processing method.

In order to solve the above problems, a first aspect of the first invention provides an image forming apparatus including: a plurality of emulators which converts print data into image data; an emulator specifying unit which specifys, from among plurality of emulators an emulator corresponding to a type of print data that has been inputted; an additional information acquisition unit which acquires additional information from the print data to supply the additional information to a predetermined emulator; and an image combining unit which combines first image data generated by the emulator specified by the emulator specifying unit and second image data generated by the predetermined emulator.

The emulators convert print data of different types into image data. The emulator specifying unit decides the type of input image data to specify an emulator corresponding to a type of the print data. The specified emulator converts the input print data into the first image data.

The additional information acquisition unit acquires additional information from the print data to supply the acquired additional information to a predetermined emulator. The predetermined emulator converts the additional information into second image data. The image combining unit combines the first image data representing a main image and the second image data representing an additional information image to each other to output the combined image.

Therefore, according to the first aspect, an emulator corresponding to the type of print data converts the print data into first image data, a predetermined emulator generate second image data on the basis of additional information to combine the first and second image data to each other, so that the second image data of a predetermined form can be always obtained with respect to the first image data formed on the basins of print data of an arbitrary type.

A second aspect of the invention provides an image forming apparatus according to the first aspect, wherein the predetermined emulator generates image data of a character or a symbol by using a predetermined font. The predetermined font mentioned here may be a font the type, size, and the like of which are set in advance.

Therefore, according to the second aspect, the second image data using a predetermined font can be always obtained regardless of the type of predetermined data.

A third aspect of the invention provided an image forming apparatus according to the first and second aspects, wherein the image combining unit combines an image obtained by the second image data and an image obtained by the first image data such that the image obtained by the second image data is located at a predetermined position in the image obtained by the first image data.

Therefore, according to the third aspect, an image based on additional information can be located at a predetermined position.

A print data processing device according to the second invention includes: an input unit which inputs print data including image-data-converted data to be converted into image data, forming information representing a form in, which the image-data-converted data has been formed, and additional information formed in a predetermined form; a specifying unit which specifys, on the basis of the form information in the input print data, a converting method for converting the image-data-converted data in the print data into image data, from among a plurality of converting methods including a predetermined converting method for converting the additional information formed in the predetermined form into image data, the plurality of converting methods converting the image-data-converted data into image data in unique forms, a combining unit which combines first image data obtained by converting the image-data-converted data in the input print data by the converting method specified by the specifying unit and second image data obtained by converting the additional information in the input print data by the predetermined converting method.

A print data processing method according to the third invention comprises the step of: inputting print data including image-data-converted data to be converted into image data, forming information representing a form in which the image-data-converted data has been formed, and additional information formed in a predetermined form; specifying, on the basis of the form information in the input print data, a converting method for converting the image-data-converted data in the print data into image data, from among a plurality of converting methods including a predetermined converting method for converting the additional information formed in the predetermined form into image data, the plurality of converting method converting the image-data-converted data into image data in unique forms; and combining first image data obtained by converting the image-data-converted data in the input print data by the converting method specified by the specifying unit to second image data obtained by converting, the additional information in the input print data by the predetermined converting method.

### BRIEF DESCRIPTION OF THE DRAWINGS

FIG. 1 is a block diagram showing the configuration of an image forming apparatus according to an embodiment of the present invention.

FIG. 2 is a diagram showing the configuration of PDL data input to an image processing apparatus.

FIG. 3 is a diagram for explaining a state in which an image is generated from the PDL data.

### DESCRIPTION OF THE PREFERRED EMBODIMENT

An Embodiment of the present invention will be described below with reference to the accompanying drawings.

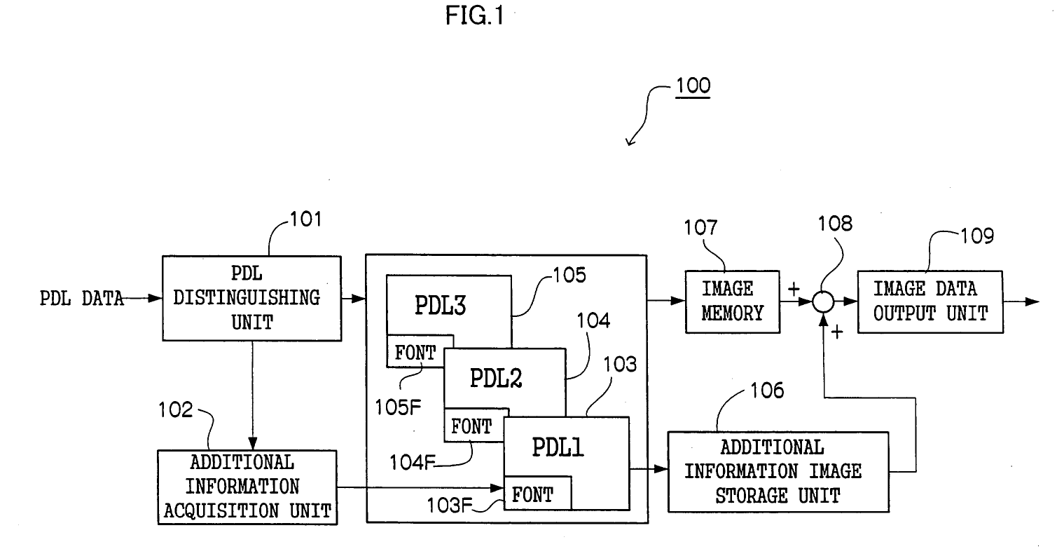

FIG. 1 is a diagram showing the configuration of an image processing apparatus 100 serving as an image forming apparatus including a print data processing device according to the embodiment of the invention.

The image processing apparatus 100 comprises a PDL distinguishing unit 101 for distinguishing PDL (Page Description Language) data, an additional information acquisition unit 102 for acquiring additional information from the PDL data, PDL interpreters 103, 104, and 105 for converting the PDL data into image data, an additional information image storage unit 106 for temporarily storing an additional information image therein, an image memory 107 for temporarily storing a main image, an image combining unit 108 for combining the main image and the additional information image to each other, and an image data output unit 109 for outputting combined image data.

The PDL interpreters 103, 104, and 105 are emulators for interpreting the input PDL data to convert the PDL data into Raster data (image data). The PDL interpreters 103, 104, and 105 have outline font data 103F, 104F, and 105F. When PDL data are supplied to the PDL interpreters 103, 104, and 105, the PDL interpreters 103, 104, and 105 form main images with reference to the outline font data 103F, 104F, and 105F, respectively.

The PDL interpreters 103, 104, and 105 are different emulators. Therefore, in formation of the main images, one of the PDL interpreters 103, 104, and 105 is started depending on the type of PDL data. For example, when the PDL data is of PostScript (R) form, the PDL interpreter 104 is started.

The PDL interpreter 103 has not only a function of interpreting PDL data to form a main image but also a function of forming an additional information image. In formation of an additional information image, the PDL interpreter 103 generates an additional information image (character image) having a predetermined font type and a predetermined size in a predetermined image size on the basis of ASCII character string data with reference to the outline font data 103F.

When the image processing apparatus 100 constituted as described above receives PDL data of, e.g., PostScript (R) form as print data, the image processing apparatus 100 executes processes in the following order.

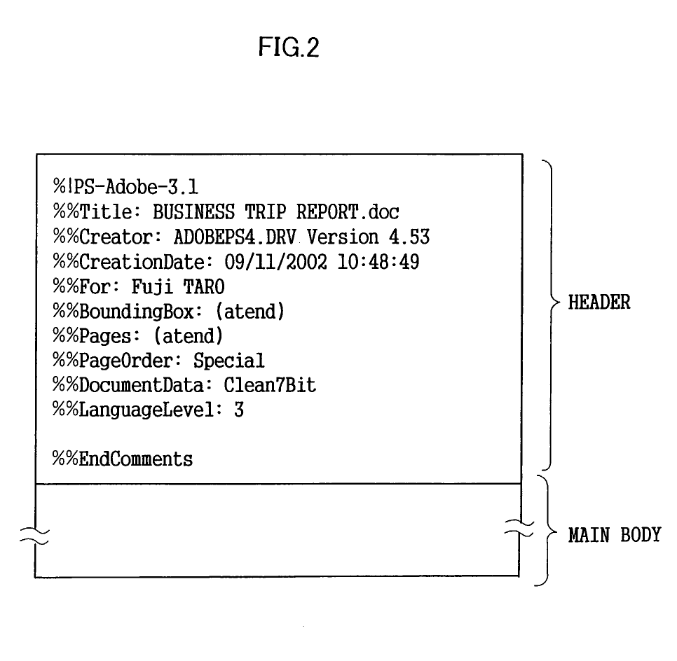

FIG. 2 is a diagram showing the configuration of PDL data input to the image processing apparatus 100. The PDL data is constituted by a header and a main body (corresponding to image-data-converted data). In the header, “%!PS” (corresponding to forming information) representing PostScript (R) form, additional information formed by an ASCII character string, various job parameters, and the like are described.

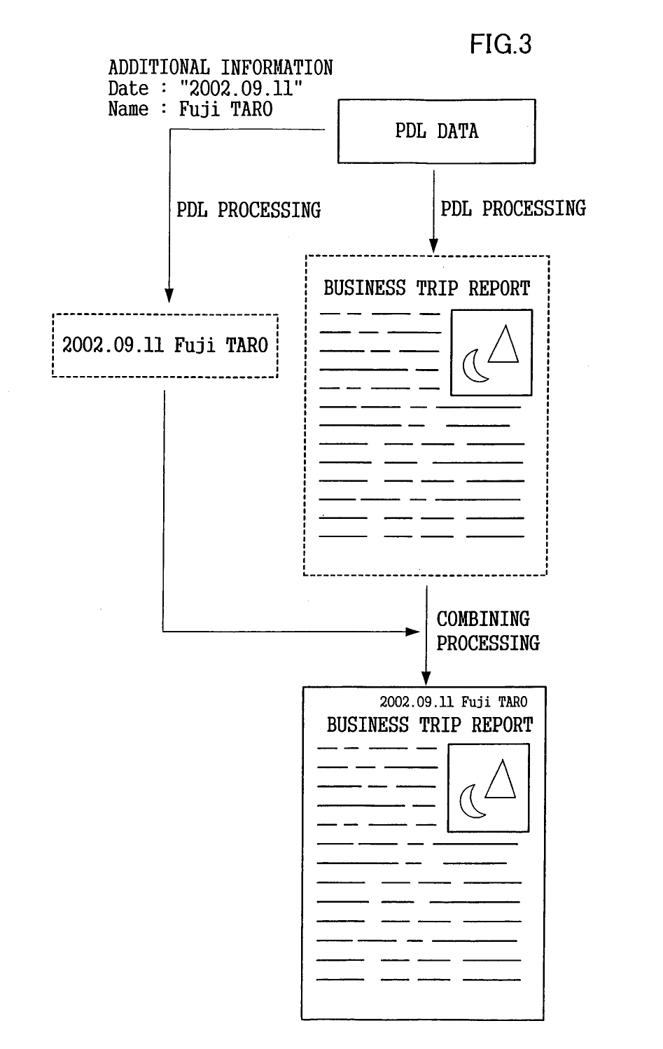

FIG. 3 is a diagram for explaining a state in which an image is generated by PDL data.

The PDL distinguishing unit 101 analyzes the forming information in the format of the input PDL data, and specifies a PDL interpreter which must interpret PDL data in the plurality of PDL interpreters 103, 104, and 105.

For example, when PDL data which starts from “%!PS” is input, the PDL distinguishing unit 101 distinguishes that the PDL data is of PostScript (R) form. The PDL distinguishing unit 101 selects the PDL interpreter 104 which can interpret data of PostScript (R) form.

The additional information acquisition unit 102 acquires additional information (formed by an ASCII character string) including a user name or the like in the input PDL data, and supplies the data of the ASCII character string to the PDL interpreter 103 which can generate a character image.

For example, when the PDL data shown in FIG. 2 is input, the additional information acquisition unit 102 acquires ASCII character string data of a preparing date “Sep. 11, 2002” and a user name “Fuji Taro” as the additional information from the PDL data to supply the ASCII character string data to the PDL interpreter 103. The additional information may include not only a preparing date and a user name but also identification information or attribute information such as a group to which one belongs, e.g., a company name, a department or section name, or the like which can differentiate one from another. As the additional information, not only the above information but also, e.g., a symbol may be used.

The PDL interpreter 103 generates a character image representing the ASCII character string “Sep. 11, 2002” and “Fuji Taro” supplied from the additional information acquisition unit 102 according to a predetermined format with reference to the outline font data 103F. In this case, the image size of the character image preferably is a predetermined size such that characters can be discriminated but are not conspicuous.

The additional information image storage unit 106 temporarily stores the character image generated by the PDL interpreter 103.

On the other hand, the PDL data is supplied to the PDL interpreter 104 specified by the PDL distinguishing unit 101.

The PDL interpreter 104 interprets the PDL data and generates Raster data of a main image with reference to the outline font data 104F. The image memory 107 temporarily stores the main image generated by the PDL interpreter 104.

The image combining unit 108 combines the character image stored in the additional information image storage unit 106 and the main image stored in the image memory 107. The combining method may be an overwriting method, and is not limited to a specific method. The character image to be combined may be located at any position on the main image. More specifically, the character image may be located at the upper left, lower left, upper right, or lower right of the main image, or may be located at a position selected by an operator.

The image data output unit 109 prints an image on the basis of the image combined by the image combining unit 108. When a print state with respect to colors or the like at a position peripheral to the position where the character image is combined into the main image is the same as to a print state of the character image, any one of the states may be changed to make the print states different from each other.

As described above, the image processing apparatus 100 according to the embodiment of the invention extracts additional information from PDL data and generates an additional information image by using the predetermined PDL an interpreter 103, so that the image processing apparatus 100 can generate integrated additional information image regardless of the type (print language) of the PDL data.

More specifically, the image processing apparatus 100 generates an additional information image by using the PDL interpreter 103 even if one of the PDL interpreter 104 and the PDL interpreter 105 is started depending on a print language. For this reason, the image processing apparatus 100 can print an integrated additional information image such as a font, a font size, a location, and the like on a main image which is an output result of different print languages.

In the image processing apparatus 100, even if the PDL interpreter 104 corresponding to a print language does not have, for example, a unique outline font data 104F, an additional information image can be always formed because the outline font data 103F of the PDL interpreter 103 is used.

In addition, the image processing apparatus 100 can always form an additional information image by using the PDL interpreter 103 even if a PDL interpreter is added to cope with an increase in the number of types of PDL data to be input. For this reason, an integrated additional information image can be printed after version upgrade.

The invention is not limited to the above embodiment. The invention can also be applied to a case in which various changes in design are made within the spirit and scope of the invention.

For example, in the above embodiment, the PDL interpreter 103 generates an additional information image. However, the PDL interpreter 104 or the PDL interpreter 105 may generate an additional information image.

For example, each PDL interpreter has unique outline font data in the above embodiment. However, for example, outline font data transmitted from the outside through a network may be used.

The PDL interpreter 103 can form not only an additional information image but also a main image depending on a printer language, as a matter of course.

What is claimed is:

1. An image forming apparatus comprising:
a plurality of emulators which convert print data into image data;
an emulator specifying unit which specifys, from among the plurality of emulators, an emulator corresponding to a type of print data that has been inputted;
an additional information acquisition unit which acquires additional information from the print data to supply the additional information to a predetermined emulator; and
an image combining unit which combines first image data generated by the emulator specified by the emulator specifying unit and second image data generated by the predetermined emulator.

2. An image forming apparatus according to claim 1, wherein the predetermined emulator generates image data of a character or a symbol by using a predetermined font.

3. An image forming apparatus according to claim 1, wherein the image combining unit combines an image obtained by the second image data and an image obtained by the first image data such that the image obtained by the second image data is located at a predetermined position in the image obtained by the first image data.

4. An image forming apparatus according to claim 1, further comprising a print processing unit which performs print processing on the basis of image data obtained by combining the first image data and the second image data by the image combining unit.

5. A print data processing device comprising:
an input unit which inputs print data including image-data-converted data to be converted into image data, forming information representing a form in which the image-data-converted data has been formed, and additional information formed in a predetermined form;
a specifying unit which specifys, on the basis of the form information in the input print data, a converting method for converting the image-data-converted data in the print data into image data, from among a plurality of converting methods including a predetermined converting method for converting the additional information formed in the predetermined form into image data, the plurality of converting methods converting the image-data-converted data into image data in unique forms; and
a combining unit which combines first image data obtained by converting the image-data-converted data in the input print data by the converting method specified by the specifying unit and second image data obtained by converting the additional information in the input print data by the predetermined converting method.

6. A print data processing device according to claim 5, wherein the additional information is identification information for identifying the image-data-converted data.

7. A print data processing device according to claim 5, wherein the additional information is identification information for identifying a subject that has formed the image-data-converted data.

8. A print data processing device according to claim 7, wherein the identification information is identification information which is character information or a symbol.

9. A print data processing device according to claim 8, wherein, when the identification information is character information, the character information is identification information which includes at least a name.

10. A print data processing device according to claim 5, wherein the converting method is an emulation program.

11. An image forming apparatus according to claim 5, wherein the combining unit combines an image obtained by the second image data and an image obtained by the first image data such that the image obtained by the second image data is located at a predetermined position in the image obtained by the first image data.

12. An image forming apparatus according to claim 5, wherein the combining unit combines an image obtained by the second image data and an image obtained by the first image data such that the image obtained by the second image data is located at a selected position in the image obtained by the first image data.

13. An image forming apparatus comprising:
a print data processing device according to claim 5; and
a print processing unit which performes print processing on the basis of image data obtained by the combining unit of the print data processing device combining the first image data and the second image data.

14. A print data processing method comprising the steps of:
inputting print data including image-data-converted data to be converted into image data, forming information representing a form in which the image-data-converted data has been formed, and additional information formed in a predetermined form;
specifying, on the basis of the form information in the input print data, a converting method for converting the image-data-converted data in the print data into image data, from among a plurality of converting methods including a predetermined converting method for converting the additional information formed in the predetermined form into image data, the plurality of converting mathod converting the image-data-converted data into image data in unique forms; and
combining first image data obtained by converting the image-data-converted data in the input print data by the converting method specified by the specifying unit and second image data obtained by converting the additional information in the input print data by the predetermined converting method.
